(19) United States
(12) Patent Application Publication
(10) Pub. No.: US 2016/0235201 A1
(43) Pub. Date: Aug. 18, 2016

(54) Interchangeable Facing For Cabinetry

(71) Applicant: Anneli Sööt, Tampa, FL (US)

(72) Inventor: Anneli Sööt, Tampa, FL (US)

(21) Appl. No.: 14/622,707

(22) Filed: Feb. 13, 2015

(51) Int. Cl. A47B 95/00; A47B 96/00; F21V 33/00; E05C 19/16

(52) U.S. Cl. CPC A47B 95/00; E05C 19/16; A47B 96/00; F21V 33/0012; F21W 2131/301

(57) ABSTRACT

A novel interchangeable facing for cabinetry having a primary side located opposite a secondary side. The primary side of the facing is configured to have an image, a pattern, texture, or at least one color. The facing is configured to attach to a surface of the cabinet door with an attaching element. The cabinet door can have at least one recess configured to receive an attaching element. A primary portion of at least one attaching element is connected to a surface of the cabinet door. A secondary portion of at least one attaching element is connected to the secondary side of the interchangeable facing. The primary portion of at least one attaching element is configured to connect to the secondary portion of at least one attaching element, thereby, securing the interchangeable facing to the cabinet door. The cabinet door can have a concealed push to open latch.

### BACKGROUND OF THE INVENTION

1. Field of the Invention

This invention relates, generally, to an interchangeable facing for cabinetry. More particularly, it relates to a replaceable barrier for a cabinet drawer face.

2. Background Art

Cabinetry exists in areas including, but not limited to, commercial, office, hospital, and residential living. Cabinetry on the market can be finished with a wood stain or paint. Cabinetry can also be re-finished with a differing wood stain or paint. This requires tools for disassembly of the cabinet, requires costly paints or stains, and requires the skilled labor of a professional carpenter or painter to properly refinish the cabinet. Additionally, it can be time consuming for the disassembly of the cabinet, the painting and drying process, and then the reassembly of the cabinet. Thus, there is a need for an easily replaceable cosmetic panel that can be connected to and removed from a cabinet door face by a user without the need of additional tools or the need for a professional carpenter or a professional painter.

Currently, cabinetry can also be refaced with veneer overlay. This requires tools for disassembly of the cabinet and also requires the skilled labor of a professional carpenter to properly reface the cabinet. The refacing process can be time consuming. Thus, there is a need for a replaceable cosmetic panel that can be quickly attached to a cabinet door face by a user.

During holidays and events, current cabinetry on the market can be covered with a decorative tablecloth to convey a particular theme. It is more desirable for the cabinetry to be easily accessible and to not be covered by a table cloth. There is a need for an interchangeable facing for cabinetry having a plurality of images to select from that can connect to a cabinet door face without hindering the functionality of the cabinet door from opening and closing.

During remodeling, renovation, and construction, prior art cabinets have been overlaid with a barrier such as a drop cloth or a sheet of painter's plastic to keep construction debris including, but not limited to, paint, dirt, or dust from contaminating and damaging cabinetry. Often times this painter's plastic is ineffective and requires the time consuming preparation of taping down the plastic to keep the barrier in place and keeping the plastic from sliding off the cabinetry. Thus, there is a need for a cabinetry barrier that can be quickly attached to a cabinet and can efficiently protect a cabinet surface from damage by contaminants.

Additionally, cabinetry in a hospital or medical office setting is often not covered with a barrier and results in the cabinetry being contaminated with bacteria and viruses from patient contact. Further, cabinetry can be exposed to bio-hazard contaminants including, but not limited to, bodily fluids, blood borne pathogens, and aerosols. There is a need for a protective sanitation barrier for cabinetry that can be easily replaceable to prevent the spread of disease.

However, in view of the prior art considered as a whole at the time the present invention was made; it was not obvious to those of ordinary skill in the pertinent art how the identified needs could be fulfilled.

### SUMMARY OF THE INVENTION

The long-standing but heretofore unfulfilled need for a replaceable barrier configured to connect to cabinetry, whereby, a contoured facing closely conforms to a door face when at least one retaining lip is connected to at least one side of the cabinet, and a surface of the replaceable barrier is adapted to have an image or text and which also includes improvements that overcome the limitations of prior art replaceable barriers for cabinetry, is now met by a new, useful, and non-obvious invention.

The novel interchangeable facing for cabinetry has a cabinet having a contoured facing configured to attach to a surface of a cabinet including, but not limited to, a drawer face or a door. The contoured facing has a primary side located opposite a secondary side. The contoured facing is integrally contoured to form to the contour features of a door, thereby securing the facing to the door. The contoured facing has at least one retaining lip configured to conform to at least one side of a cabinet door. It is also within the scope of this invention for at least one retaining lip to be configured to conform to a plurality of sides of a cabinet door. In a preferred embodiment, an upper retaining lip is located opposite a lower retaining lip. The upper retaining lip is configured to conform to an upper side of a cabinet door and the lower retaining lip is configured to conform to a lower side of a cabinet door. A door includes, but is not limited to, a face of a drawer.

The interchangeable facing for cabinetry can be used for updating or changing the look of a cabinet system for cosmetic purposes. In a preferred embodiment, the primary side of the contoured facing is configured to have an image. The image can be any pattern, texture, at least one color, a plurality of colors, or a custom image selected by a user. A custom image includes, but is not limited to, an image derived from a digital computer file or an image selected from a computer database of images. An image theme includes, but is not limited to, a seasonal theme, a holiday theme, a children's theme, or a special event theme. For example, the interchangeable facing for cabinetry could have an image of a turkey for Thanksgiving. In another example, the image could be of an animal theme for children's room cabinetry.

In another embodiment, the primary side of the contoured facing can have text.

The text is human readable data including, but not limited to, text corresponding to the content within a cabinet drawer, a logo, a user name, a slogan, an advertisement, a warning label. For instance, the cabinet could be filled with toys and the facing would read “Toys”. In another example, the cabinet could contain utensils and the interchangeable facing could have text reading “utensils”. In another example, a hospital cabinet having the interchangeable facing could have text reading, “Biohazard” or “Gowns”. It is within the scope of this invention for the contoured facing to be free of any images or text.

In another embodiment, the interchangeable facing for cabinetry can be used for a protective barrier for sanitation. It is within the scope of this invention for the interchangeable facing to be clear or transparent. For example, in a school class room, a hospital setting, or in a medical office, the interchangeable facing can be used as a protective sanitation barrier. For example, the interchangeable facing could be disposed of and replaced when contaminated by a patient or replaced in between a first patient visit and a second patient visit.

In another embodiment, the interchangeable facing for cabinetry can be used as a protective barrier for construction, renovation, or remodeling debris. For instance, a user could connect the interchangeable facing over existing cabinetry as a protective barrier from paint overspray to protect the cabinet door facing.

In an alternate embodiment, the interchangeable facing is configured to attach to a surface of the cabinet door. The interchangeable facing is made of a magnetically attractive material having a primary side located opposite a secondary side. At least one magnet is connected to a surface of the cabinet door. The interchangeable facing is configured to magnetically connect to at least one magnet of the cabinet door, thereby, securing the interchangeable facing to the cabinet door. In a preferred embodiment, the secondary side of the interchangeable facing being of a magnetically attractive material is in magnetic communication with at least one magnet located on a cabinet door face, thereby, securing the interchangeable facing to the cabinet door. In another embodiment, the primary side of the facing is configured to have an image. In another embodiment, the primary side of the facing is configured to have text.

In an alternate embodiment, the interchangeable facing for cabinetry has a cabinet door having a facing connected thereto. The facing has a primary side located opposite a secondary side. The facing is configured to attach to a surface of the cabinet door with at least one attaching element. A primary portion of at least one attaching element is connected to a surface of the cabinet door. A secondary portion of at least one attaching element is connected to the secondary side of the interchangeable facing. The attaching element includes, but is not limited to, a hook and loop attachment, a snap, a magnet, adhesive, double sided tape, or tape. The primary portion of at least one attaching element is configured to connect to the secondary portion of at least one attaching element, thereby, securing the interchangeable facing to the cabinet door.

Further, the cabinet door can have a concealed push to open latching mechanism including, but not limited to, a polar magnetic deadbolt latch, a push-to-open touch latch, a pin latch, or a magnetic catch latch. This concealed latch allows the door facing to be unobstructed by a door handle. This concealed latch also allows for the door to be opened and closed without the door needing a handle and without the need to alter the facing, such as by adding an opening to receive a door handle. However, it is within the scope of this invention for the facing to have an opening configured to receive a door handle so the facing can be applied to existing cabinetry having handles.

In another embodiment, the cabinet door can have at least one recess configured to receive an attaching element including, but not limited to, a magnet. When a magnet is inserted into the recess, the magnet does not protrude from the door surface. It is more desirable for the magnet to be flush with the door surface.

It is within the scope of this invention for cabinet land/or door 2 to have a locking mechanism to secure door 2 in a locked configuration. The locking mechanism can be in a concealed location as not to obstruct the door facing. The lock can include, but is not limited to, a lock and key, a key pad lock, a digital lock, a thumb lock, or a numerical lock.

It is also within the scope of this invention for cabinet door 2 and/or facing 5 to have at least one opening (not shown). The opening is configured to receive, suspend, and display to a user, a vessel within the door opening. The opening is great enough in size to receive the vessel. A vessel includes, but is not limited to, a bottle, a glass, a goblet, a mug, or a cup. The vessel can be secured within the door opening with a fastener or support member including, but not limited to a screw, an adjustable screw, a rod, or a compression spring. An opening can be located on an edge of the door to receive the fastener to secure an object within at least one opening. A cabinet door having an opening can have a facing having an opening. When the facing has at least one opening, the opening allows the suspended vessel to be visible within the cabinet door while the facing is connected to the cabinet door simultaneously. The door can have a push-to close latching mechanism. The door can have at least one light emitting unit configured to illuminate the vessel when retained within the door opening.

A cabinet has a cabinet door having at least one opening configured to retain a vessel. The at least one opening has at least two support members configured to suspend the vessel within the opening. The two support members support the vessel at at least two contact points. There can be a plurality of contact points depending on the size and weight of the vessel.

In an embodiment, the contact points can be spring loaded. For example, when the vessel is inserted into the opening of the door, a compression spring contacts a support member and secures the vessel within the opening.

In another embodiment, the contact points can also be solid points, whereby, the support members contact a contact point of the vessel and do not allow the vessel to be repositioned unless the support members are removed.

In another embodiment, the contact points can be repositioned with adjustable fasteners including, but not limited to, a thumb screw or a screw.

It is within the scope of this invention for the door to be configured to have a light emitting unit, whereby, when the door is positioned in an open configuration, the light is powered on. When the door is positioned in a closed configuration, the light is powered off. At least one light emitting unit can be positioned inside the cabinet on a surface of the cabinet. It is a preferred embodiment for the light emitting unit to be connected to a surface of the cabinet including, but not limited to, a perimeter of the cabinet opening.

### BRIEF DESCRIPTION OF THE DRAWINGS

For a fuller understanding of the nature and objects of the invention, reference should be made to the following detailed description, taken in connection with the accompanying drawings, in which:

FIG. 1 is a front perspective view of the novel interchangeable facing adapted to be connected to a cabinet door, the cabinet door having a recess configured to receive and retain an attaching element;

FIG. 2 is an exploded view of the novel interchangeable facing adapted to be connected to a cabinet door with an attaching element connected to a surface of the door;

FIG. 3 is a side cut-away view of the novel interchangeable facing having a contoured facing adapted to conform to a cabinet door; and,

FIG. 4 is a rear view of the novel interchangeable facing having a contoured facing configured to conform to a cabinet door.

FIG. 5 is a perspective view of the novel interchangeable facing being made of a magnetically attractive material having a surface that is adapted to be magnetically connected to a magnet located on a surface of a cabinet door, whereby the interchangeable facing has another surface having an image or text.

### DETAILED DESCRIPTION OF THE PREFERRED EMBODIMENT

In the following detailed description of the preferred embodiments, reference is made to the accompanying drawings, which form a part hereof, and within which are shown by way of illustrating specific embodiments by which the invention may be practiced. It is to be understood that other embodiments may be utilized and structural changes may be made without departing from the scope of the invention.

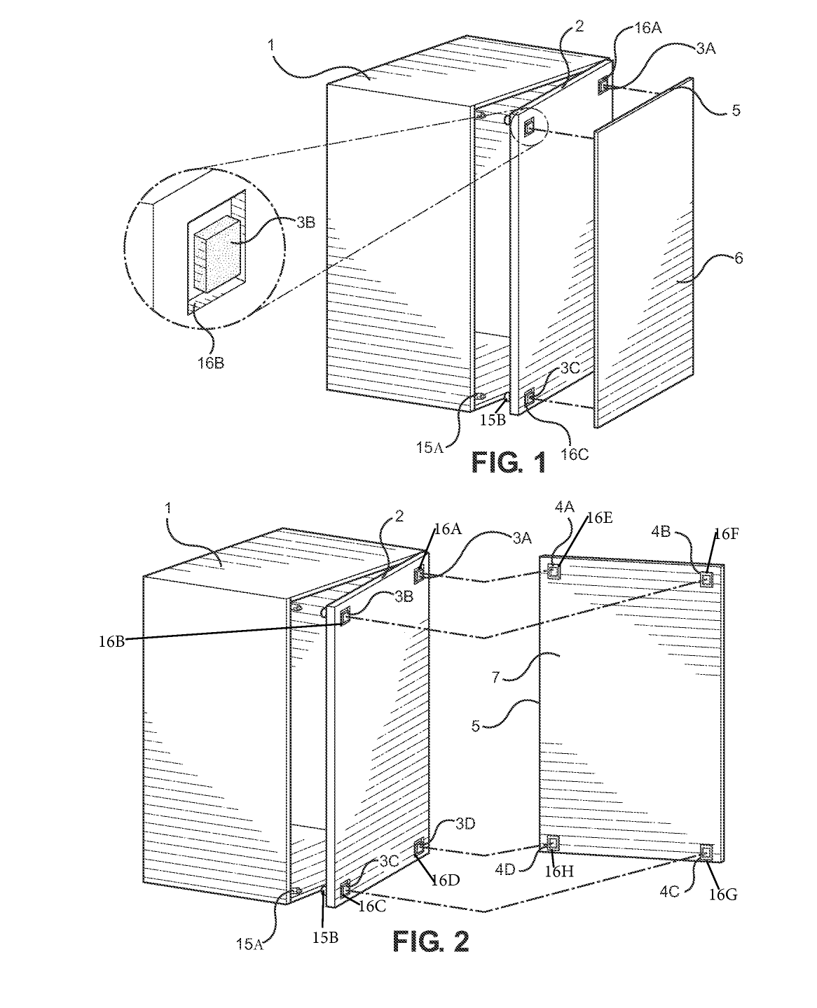

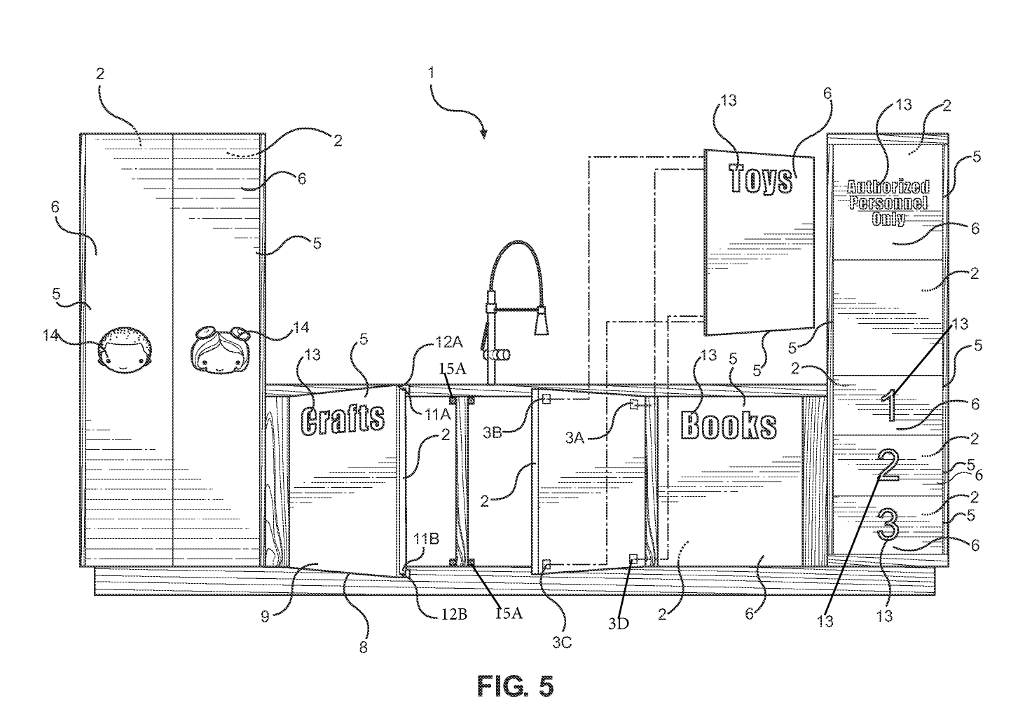

In a preferred embodiment, FIGS. 1 and 2 show cabinet 1 having door 2. It is within the scope of this invention for a door to include, but not be limited to, a face of a drawer. Attaching element primary portions 3A, 3B, 3C, and 3D (FIG. 2) are located on a surface of door 2. Facing 5 has primary side 6 (FIG. 1) located opposite secondary side 7 (FIG. 2). Facing 5 primary side 6 is adapted to have including, but not limited to, color, texture, text 13 (FIG. 5) or image 14 (FIG. 5). Attaching element secondary portions 4A, 4B, 4C, and 4D (FIG. 2) are located on a surface of facing 5. It is a preferred embodiment that attaching element secondary portions 4A, 4B, 4C, and 4D (FIG. 2) are located on secondary side 7 of facing 5. It is within the scope of this invention for attaching element secondary portion 4A to be retained within recess 16E of facing 5, attaching element secondary portion 4B to be retained within recess 16F of facing 5, attaching element secondary portion 4C to be retained within recess 16G of facing 5, and attaching element secondary portion 4D to be retained within recess 16H of facing 5. Facing 5 is secured to door 2 when attaching elements primary portions 3A, 3B, 3C, and 3D of door 2 connect with attaching elements secondary portions 4A, 4B, 4C, and 4D of facing 5.

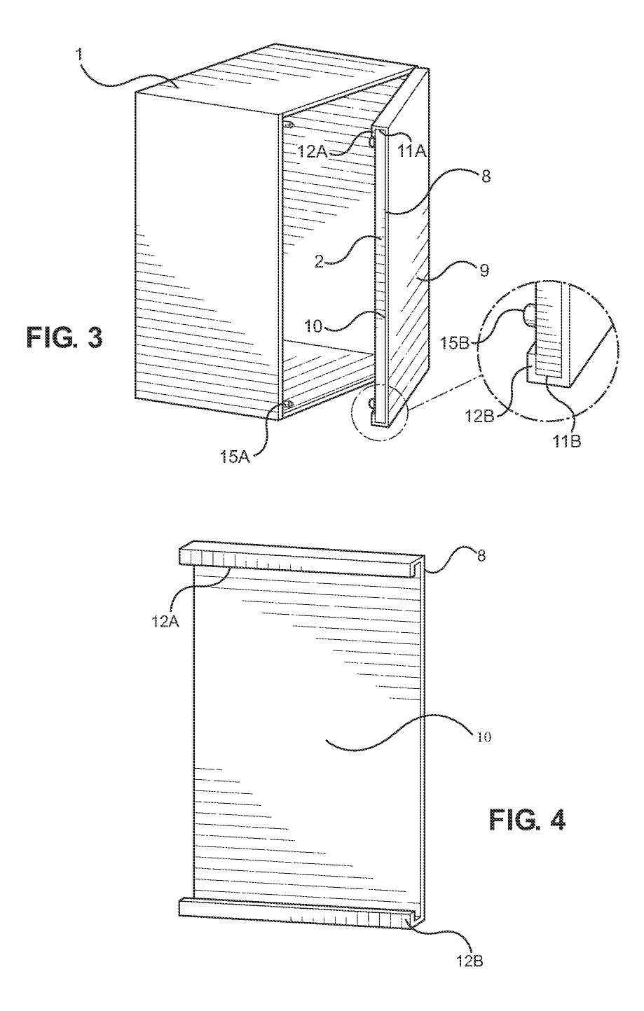

FIGS. 1-3 best show cabinet 1 having concealed push-to-open touch latches 15A and 15B (FIG. 3). Concealed push-to-open touch latch primary portion 15A is connected to a portion of cabinet surface 1 and concealed push-to-open touch latch secondary portion 15B is located on a concealed portion of door 2. Concealed push-to-open touch latch primary portion 15A is located opposite concealed push-to-open touch latch secondary portion 15B. When door 2 is closed and pressed inward toward cabinet 1, concealed push-to-open touch latch primary portion 15A and concealed push-to-open touch latch secondary portion 15B connect and are secured together.

FIG. 1 illustrates door 2 having recess 16A configured to receive attaching element 3A, recess 16B is configured to receive attaching element 3B, recess 16C is configured to receive attaching element 3C, and recess 16D (FIG. 2) is configured to receive attaching element 3D (FIG. 2). When attaching element 3A is inserted into recess 16A, attaching element 3A is flush with the surface of door 2, whereby, attaching element 3A does not protrude from recess 16A. The recess is configured to receive and retain the attaching element within the recess.

As best shown in FIG. 3, cabinet 1 has door 2 having contoured facing 8 having retaining lip 12A and retaining lip 12B. Retaining lip 12A is configured to conform to primary side 11A of door 2. Retaining lip 12B is configured to conform to secondary side 11B of door 2. Contoured facing 8 has primary side 9 located opposite secondary side 10. Contoured facing primary side 9 is configured to have at least one image or text (FIG. 5). Contoured facing secondary side 10 is configured to abut a surface of door 2.

FIG. 4 depicts a portion of contoured facing 8 having retaining lip 12A configured to conform to primary side 11A (FIG. 3) of door 2. Retaining lip 12B is configured to conform to primary side 11B (FIG. 3) of door 2. Retaining lip 12A is located opposite Retaining lip 12B. It is within the scope of this invention for contoured facing 9 to have at least one retaining lip.

As best shown in FIG. 5, cabinet 1 can have facing 5 being of a magnetically attractive material in magnetic communication with magnets 3A, 3B, 3C, and 3D located on a surface of door 2. Primary side 6 of facing 5 has including, but not limited to, text 13 or has at least one image 14. FIG. 5 also depicts an embodiment of contoured facing 8 having retaining lips 12A and 12B configured to conform to or wrap around an outer perimeter edge 11A and 11B of door 2. Retaining lip 12A conforms to primary edge 11A of door 2. When primary edge 11A of door 2 is inserted into retaining lip 12A, contoured facing 8 is secured to door 2. Retaining lip 12B in configured to conform to secondary outer perimeter edge 11B of door 2 for additional support.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

The invention claimed is:

1. An interchangeable facing for cabinetry, comprising:
a cabinet door having an integrally formed contoured facing configured to attach to a surface of said cabinet door, whereby, said contoured facing having a first side located opposite a second side; and,
said contoured facing having at least one retaining lip, said at least one retaining lip configured to conform to at least one side of said cabinet door.

2. The interchangeable facing for cabinetry of claim 1, wherein said contoured facing is integrally formed.

3. The interchangeable facing for cabinetry of claim 1, wherein said first side of said contoured facing having an image.

4. The interchangeable facing for cabinetry of claim 1, wherein said first side of said contoured facing having text.

5. The interchangeable facing for cabinetry of claim 1, wherein said cabinet door having a first portion of a pressure latch connected thereto, said cabinetry having a second portion of a pressure latch connected thereto, whereby, said first portion of said pressure latch is located opposite said second portion of said pressure latch, said first portion of said pressure latch is configured to connect to said second portion of said pressure latch.

6. The interchangeable facing for cabinetry of claim 1, wherein said cabinetry having a light emitting unit, whereby, when said cabinet door is positioned in an open configuration, said light emitting unit is powered “on”.

7. An interchangeable facing for cabinetry, comprising:
a door having a facing configured to attach to a surface of said door, whereby, said facing being of a magnetically attractive material having a first side located opposite a second side;
at least one magnet is connected to a surface of said door; and,
said facing configured to magnetically connect to said at least one magnet when said second side of said facing is connected to said at least one magnet.

8. The interchangeable facing for cabinetry of claim 7, wherein said first side of said facing having an image.

9. The interchangeable facing for cabinetry of claim 7, wherein said first side of said facing having text.

10. The interchangeable facing for cabinetry of claim 7, wherein said door having a first portion of a pressure latch connected thereto, said cabinetry having a second portion of a pressure latch connected thereto, whereby, said first portion of said pressure latch is located opposite said second portion of said pressure latch, said first portion of said pressure latch is configured to connect to said second portion of said pressure latch.

11. The interchangeable facing for cabinetry of claim 7, wherein said door having at least one recess located on a surface of said door, said at least one recess is configured to receive an attaching element, whereby, said at least one recess retains said attaching element.

12. The interchangeable facing for cabinetry of claim 7, wherein said cabinetry having a light emitting unit, whereby, when said door is positioned in an open configuration, said light emitting unit is powered “on”.

13. An interchangeable facing for cabinetry, comprising:
a cabinet door having a facing, said facing having a first side located opposite a second side, said facing configured to attach to a surface of said cabinet door, whereby, a first portion of at least one attaching element is connected to a surface of said cabinet door, a second portion of said at least one attaching element is connected to said second side of said facing, whereby, said first portion of said at least one attaching element is configured to connect to said second portion of said at least one attaching element, thereby, securing said facing to said cabinet door.

14. The interchangeable facing for cabinetry of claim 13, wherein said first side of said facing having an image.

15. The interchangeable facing for cabinetry of claim 13, wherein said first side of said facing having text.

16. The interchangeable facing for cabinetry of claim 13, wherein said facing having at least one recess located on a surface of said facing, said at least one recess is configured to receive an attaching element, whereby, said at least one recess retains said attaching element.

17. The interchangeable facing for cabinetry of claim 13, wherein said cabinet door having a first portion of a pressure latch connected thereto, said cabinetry having a second portion of a pressure latch connected thereto, whereby, said first portion of said pressure latch is located opposite said second portion of said pressure latch, said first portion of said pressure latch is configured to connect to said second portion of said pressure latch.

18. The interchangeable facing for cabinetry of claim 13, wherein said cabinet door having at least one recess located on a surface of said cabinet door, said at least one recess is configured to receive an attaching element, whereby, said at least one recess retains said attaching element.

19. The interchangeable facing for cabinetry of claim 13, wherein said cabinetry having a light emitting unit, whereby, when said cabinet door is positioned in an open configuration, said light emitting unit is powered “on”.

20. A cabinet, comprising;
a door having at least one opening configured to retain a vessel;
said at least one opening having at least two support members configured to suspend said vessel within said opening; and,
said at least two support members supporting said vessel at at least two contact points.
